(19) United States
(12) Patent Application Publication
(10) Pub. No.: US 2007/0182994 A1
(43) Pub. Date: Aug. 9, 2007

(54) Image processing apparatus

(75) Inventor: Tomoya Yoshida, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA BUSINESS TECHNOLOGIES, INC., Tokyo (JP)

(21) Appl. No.: 11/446,847

(22) Filed: Jun. 5, 2006

(30) Foreign Application Priority Data
Feb. 7, 2006 (JP) JP2006-029106

(51) Int. Cl. G06K 15/00

(52) U.S. Cl. 358/1.18

(57) ABSTRACT

There is described an image processing apparatus, which makes it possible to calculate the account fee corresponding to the using status of the control program downloaded from an external device, or corresponding to the using status of the control programs installed in the image processing apparatus in advance. The image processing apparatus includes: an obtaining section to obtain the control program from the external device; a storage section to temporarily store the control program; a detection section to detect status of use of the control program; a calculation section to calculate fee for the control program based on the status of use of the control program; and a selection section to accept selection for a desired function, which becomes available at the image processing apparatus by obtaining the control program. The obtaining section downloads and obtains control program corresponding to the selected function from the external device.

### RELATED APPLICATION

This application is based on Japanese Patent Application NO. 2006-029106 filed on Feb. 7, 2006 in Japanese Patent Office, the entire content of which is hereby incorporated by reference.

### BACKGROUND

1. Field of the Invention

The present invention relates to an image processing apparatus, which executes a control program downloaded from the external terminal device.

2. Description of the Related Art

Recently, the multi-functionalizing trend of the image processing apparatus, such as a multi-function apparatus having a copy capability, a printer capability, etc., has been progressed further, and accordingly, most of the optional functions can be implemented by executing a newly added software without changing the configuration of the hardware.

Conventionally, on a sales point of view, in most of such the cases, an extra fee has been established even for such the optional function implemented by executing a newly added software. In other words, there has been employed such the sales method that, after the user purchases desired software and once downloads it into the nonvolatile storage of the user's apparatus, the user can freely use the optional function implemented by the purchased software.

Further, to reduce the capacity of the firmware to be provided in an apparatus, there has been recently introduced in the market such the apparatus that stores only the boot program and the downloading program in its ROM (Read Only Memory), while downloading all of other control programs from external apparatuses through the network (for instance, set forth in Patent Document 1).

Still further, there has been also proposed such a system that recognizes the hardware configurations included in the system at the time of activating the system, and then, automatically selects the control program modules necessary for the recognized hardware configurations to download the selected control program modules into the system (for instance, set forth in Patent Document 2).

[Patent Document 1]
Tokkai 2002-211086 (Japanese Non-Examined Patent Publication)

[Patent Document 2]
Tokkai 2005-111670 (Japanese Non-Examined Patent Publication)

The frequency of using a specific optional function varies depending on the user's needs, compared to the fundamental function, such as the copy function, etc. A certain user would use the specific optional function several times a year, while another user would temporarily use the specific optional function for a temporal need at once, but there would be no need for using it after that. Accordingly, in the conventional sales method in which the user purchases the software itself to download it into the user's apparatus, the fee for the optional function is very expensive for the user whose frequency of using the optional function is very low, resulting in considerable increase of economical load of the user. For this reason, the user would hesitate to purchase such the software.

On the other hand, in the technical methods set forth in Patent Document 1 or Patent Document 2, since all of control programs except the boot program and the downloading program are downloaded at the time of activating the system, or since the control program modules corresponding to the hardware configurations are automatically selected to download the selected control program into the system, the software, with respect to all of the optional functions being available for the hardware configurations, are downloaded, resulting in an inability of appropriate sales management of the optional functions.

### SUMMARY

To overcome the abovementioned drawbacks in conventional image-recording apparatus, it is an object of the present invention to provide an image processing apparatus, which makes it possible to calculate the account fee corresponding to the using status of the control program downloaded from an external terminal device to use it, or corresponding to the using status of the control programs installed in the image processing apparatus in advance.

In view of foregoing, an object of this invention is to solve at least one of the problems, and to provide new image processing apparatus. The image processing apparatus, which downloads control program from an external device and uses it, comprises: an obtaining section to obtain the control program from the external device; a storage section to temporarily store the control program; a detection section to detect status of use of the control program; and a calculation section to calculate fee for the control program based on the status of use of the control program.

According to another aspect of the present invention, the image processing apparatus, which provides a function by using a control program, comprises: a storage section to store the control program; a detection section to detect status of use of the control program; and a calculation section to calculate fee for the control program based on the status of use of the control program.

The invention itself, together with further objects and attendant advantages, will best be understood by reference to the following detailed description taken in conjunction with the accompanying drawings.

### BRIEF DESCRIPTION OF THE DRAWINGS

Other objects and advantages of the present invention will become apparent upon reading the following detailed description and upon reference to the drawings in which:

FIG. 1 shows a configuration of a system including an image processing apparatus embodied in the present invention;

FIG. 2 shows a block diagram indicating a rough configuration of an image processing apparatus embodied in the present invention;

FIG. 3 shows an exemplified selecting screen for selecting a control program to be downloaded for every function;

FIG. 4(a), FIG. 4(b), FIG. 4(c), show data structures of data sets to be stored in a ROM, a nonvolatile storage and a DRAM;

FIG. 5 shows a flowchart of operations for accumulating downloading times in order to charge an account fee for every predetermined time period;

FIG. 6 shows a flowchart of operations for limiting a number of downloading times within a predetermined time period to charge an account fee established in advance; and

FIG. 7 shows a flowchart of operations for charging an account fee corresponding to a number of function uses.

### DETAILED DESCRIPTION OF THE PREFERRED EMBODIMENT

Referring to the drawings, the embodiment of the present invention will be detailed in the following.

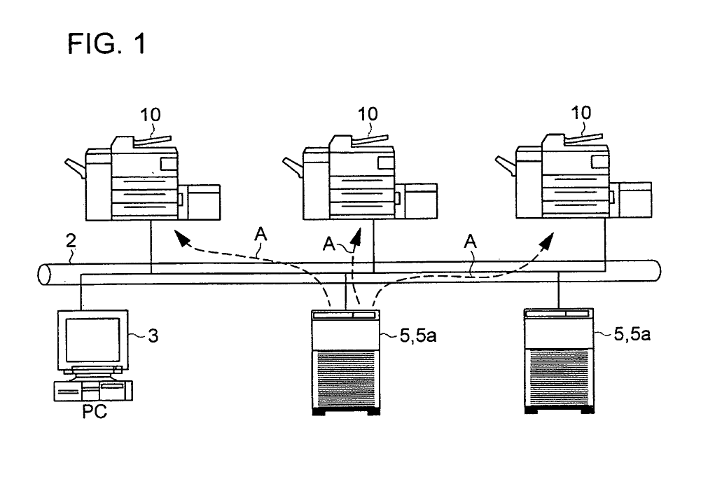

FIG. 1 shows a configuration of the system including an image processing apparatus 10, embodied in the present invention. The system is constituted by the image processing apparatuses 10 and downloading servers 5, which are coupled to each other through a network 2, such as a LAN (Local Area Network), etc. Other than the above, it is applicable that other apparatuses, such as a personal computer 3, etc., are also coupled to the network 2. The scope of the network 2 is not limited to the LAN, but would include the Wide Area Network, such as the Internet, etc. It is also applicable that the image processing apparatuses 10 and the downloading servers 5 are coupled to each other through another communication path other than the above.

The image processing apparatus 10 is configured as a multi-function apparatus that is provided with a printer function for printing an image onto a recording medium based on print data received from the personal computer 3, etc., a scanner function for reading an original document to store corresponding data into a storage and outputting them onto the network 2, a facsimile function for receiving and transmitting the image data through a communication line, etc., in addition to the copy function for creating a copy image, based on the image data read from the original document, onto the recording medium.

The image processing apparatus 10 is so constituted that the control programs are downloaded from the downloading servers 5 through the network 2 to activate the image processing apparatus 10 every time when the power switch is turned ON or the apparatus is reset. In FIG. 1, broken lines “A” schematically indicate paths through which the control programs are downloaded.

In the present embodiment, a plurality of the image processing apparatuses 10 are coupled to the network 2. Further, as the downloading servers 5, a priority downloading server 5a and an auxiliary downloading server 5b are provided in the system. The control programs are downloaded from the priority downloading server 5a prior to the auxiliary downloading server 5b, while the control programs are downloaded from the auxiliary downloading server 5b when the accessing demands are concentrated to the priority downloading server 5a, or when the priority downloading server 5a is malfunctioned. The downloading servers 5 store the control programs, being object of the downloading operation, while classifying them into every functional module. Therefore, it is possible for the image processing apparatus 10 to download the control program for every function from the downloading servers 5.

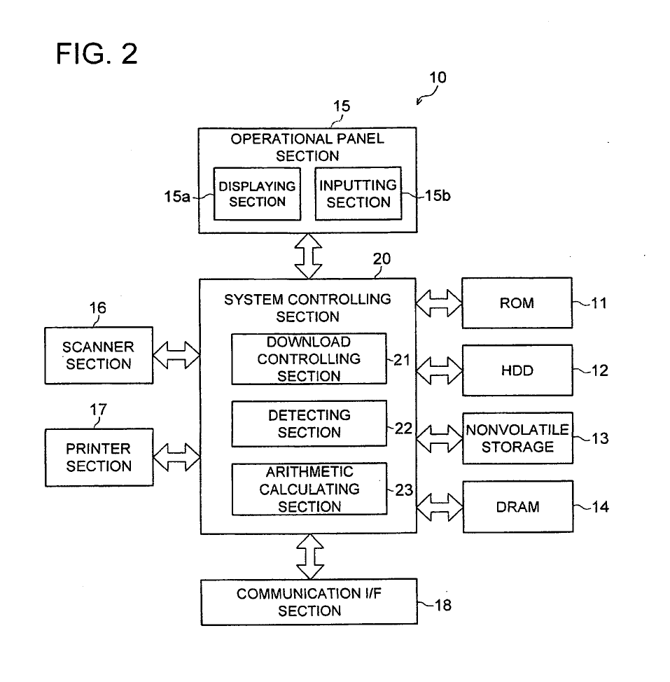

FIG. 2 shows a block diagram indicating a rough configuration of the image processing apparatus 10. The image processing apparatus 10 is constituted by coupling a ROM (Read Only Memory) 11, a HDD (Hard Disc Drive) 12, a nonvolatile storage 13, a DRAM (Dynamic Random Access Memory) 14, an operational panel section 15, a scanner section 16, a printer section 17 and a communication I/F (Interface) section 18 to a system controlling section 20.

The system controlling section 20 includes a CPU (Central Processing Unit) as its main part so as to conducts the total controlling operations for controlling the operations of the image processing apparatus 10. The ROM 11 is a read only memory in which the boot program and the downloading program (the control program to be executed for controlling the downloading operations) are stored in advance. The system controlling section 20 includes a download controlling section 21 for conducting operations for downloading the control programs, a detecting section 22 for detecting a using status of the control programs downloaded from the downloading servers 5 and an arithmetic calculating section 23 for calculating an accounting fee for the control programs based on a result detected by the detecting section 22, all of which are activated by executing the download control program stored in the ROM 11.

The HDD 12 is a mass-storage device for storing image data, etc. The nonvolatile storage 13 is a rewritable storage that retains the stored data even after the power supply is turned OFF. The DRAM 14 is a rewritable and volatile storage that erases the stored data after the power supply is turned OFF. The DRAM 14 serves as a storage device that temporarily stores the control programs downloaded from the downloading servers 5.

The operational panel section 15 is provided with a displaying section 15a constituted by a liquid-crystal display, etc., and an inputting section 15b, constituted by operation switches, a touch panel mounted on the screen of the liquid-crystal display, etc., for receiving various kinds of inputting operations conducted by the user. Other than the screen for accepting the inputting operations conducted by the user, a guiding screen, a warning screen, etc. are also displayed on the operational panel section 15. The operational panel section 15 serves as a selecting section for selecting the control program to be downloaded for every function.

The scanner section 16 serves as an outputting section for outputting the image data generated by optically reading the original document. The scanner section 16 is constituted by a line image sensor, etc.

Based on the image data inputted, the printer section 17 forms an image onto the recording medium. In this embodiment, the printer section 17 is configured as a laser printer, which employs the electro-photographic process, and therefore, includes a conveyance device, a photoreceptor drum, a charging device, a laser unit, a developing device, a transferring and separating device, a cleaning unit, and a fixing unit.

The communication I/F section 18 conducts a communication controlling function for transmitting and receiving various kinds of data to/from the personal computer 3 and the downloading servers 5 through the network 2.

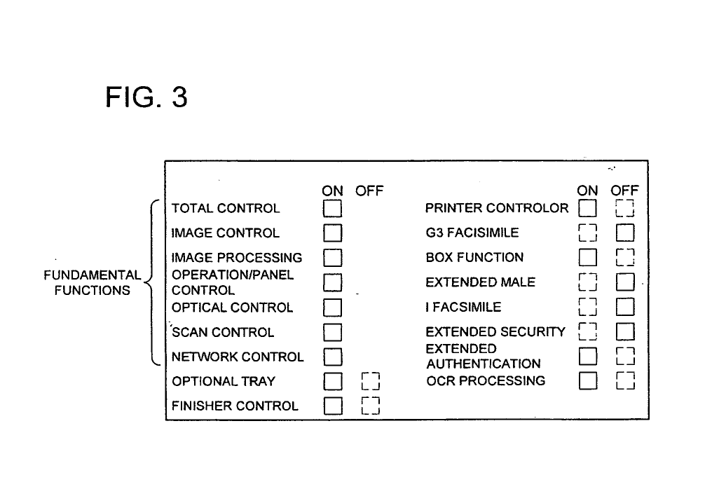

FIG. 3 shows a selecting screen 30 for selecting the control program to be downloaded for every function, as an example. The image processing apparatus 10 can accepts the selection of the control program inputted from the operational panel section 15 of the own apparatus or from the external apparatus, such as the personal computer 3, etc., coupled through the network 2. The selecting screen 30 is displayed on the displaying section 15a of the operational panel section 15 and/or the monitor device of the personal computer 3.

In the selecting screen 30, the function name of each function and an indication mark, indicating either ON (activate) or OFF (deactivate) of the downloading operation of the function concerned, are displayed in a table mode, while correlating them each other. In FIG. 3, rectangular symbols depicted by the solid lines indicate a selected status, while rectangular symbols depicted by the broken lines indicate a non-selected status. The functions indicated in the selecting screen 30 are classified into a fundamental function group and an extended function group. The fundamental functions classified into the fundamental function group are indispensable functions for activating the image processing apparatus 10 at a minimum level. Since the fundamental functions are indispensable, the selections of them are established in advance at ON statuses as the default selections, and cannot be turned OFF statuses by the user. However, with respect to the extended functions classified into the extended function group, the user can arbitrarily turn each of them either ON or OFF status.

Incidentally, the scope of the fundamental functions can be established as needed. For instance, the scope of the fundamental functions could be limited to the control programs with respect to the fundamental functions of the OS (Operating System) installed in the image processing apparatus 10 and the device drivers depending on the hardware configurations mounted or attached to the image processing apparatus 10. Further, from the user's point of view, the fundamental functions as the image processing apparatus 10, such as the copy function, a scanner function, etc., could be regarded as the fundamental functions indispensable for the downloading operation, or could be regarded as the selectable functions to be downloaded or not.

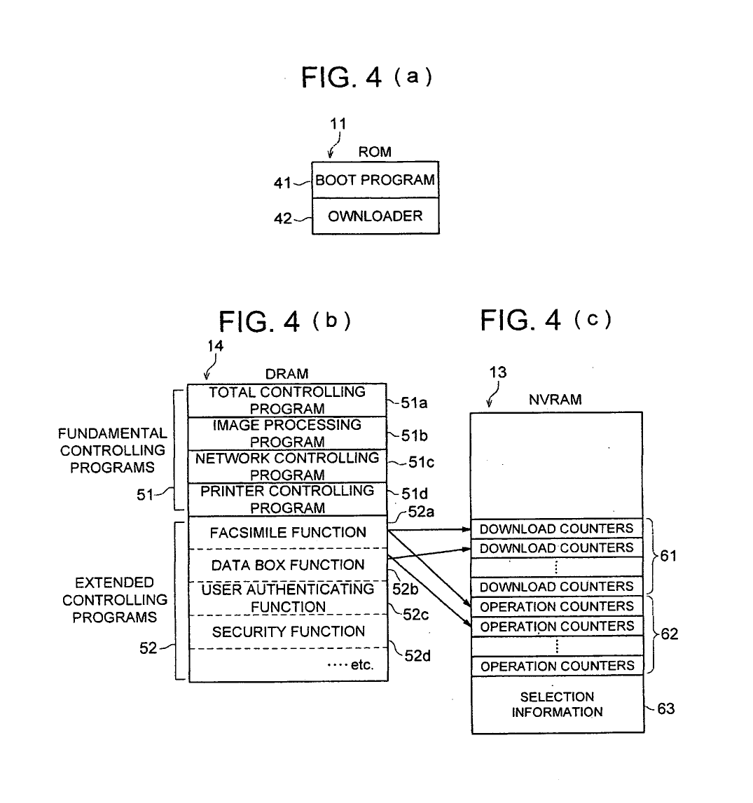

FIG. 4(a), FIG. 4(b), FIG. 4(c), show data structures of data sets to be stored in the ROM 11, the nonvolatile storage 13 and the DRAM 14. As shown in FIG. 4(a), a boot program 41 for activating the system and a downloader 42 are stored into the ROM 11. The downloader 42 is a program for controlling the operation for downloading the control programs from the downloading servers 5.

As shown in FIG. 4(b), various kinds of control programs downloaded from the downloading servers 5 are stored in the DRAM 14. In this example shown in FIG. 4(b), a total control program 51a, an image processing program 51b, a network control program 51c and a printer control program 51d are stored as fundamental control programs 51 with respect to the fundamental functions. Further, a facsimile function program 52a, a data box function program 52b, a user authenticate function program 52c, a security function program 52d, etc. are stored as extended control programs 52 with respect to the extended functions.

As shown in FIG. 4(c), download counters 61, operation counters 62 each of which corresponds to each of the extended functions and selection information 63 indicating selected contents of the selecting screen 30 shown in FIG. 3 are stored into the nonvolatile storage 13. Based on the counted values of the download counters 61 and the operation counters 62, an account fee amount for each of the functions is calculated. Further, referring to the selection information 63, the download controlling section 21 recognizes the control programs to be downloaded from the downloading servers 5.

Next, count-up examples of the download counters 61 and the operation counters 62 will be detailed in the following.

Referring to the selection information 63 stored in the nonvolatile storage 13 at the time of initial processing when the power source is turned ON, the image processing apparatus 10 downloads the fundamental control programs 51 with respect to the fundamental functions and the extended control programs 52 with respect to the extended functions selected in advance from the downloading servers 5. When downloading a specific extended function, one of the download counters 61, corresponding to the specific extended function, is counted up.

Basically, the corresponding one of the download counters 61 is counted up by “1” for every one downloading operation. However, since, sometimes, the image processing apparatus 10 is operated in such a manner that the power source is always turned ON or for a long time after the downloading operation is completed, the image processing apparatus 10 is also provided with such a function that a timer is activated at the time when the downloading operation is completed, and then, the corresponding one of the download counters 61 is automatically counted up at the time when a predetermined time period (a holding period) has elapsed, and after the downloading operation is completed, the timer is reset again. The predetermined time period (a time duration serving as a unit of the counting-up operation) set for the timer can be changed by the serviceperson, etc.

Further, an upper limit value can be set for each of the download counters 61. The upper limit values are stored in the nonvolatile storage 13. With respect to the operation of the image processing apparatus 10 after one of the download counters 61 has reached up to the upper limit value, either (1) freely available after that without any fee, or (2) ban of the operation after that until the download counter is reset, can be established by switching selection.

Incidentally, in the case of “(2) ban of the operation” in the above, when one of the download counters 61 has reached up to the upper limit value, the program module concerned is deleted from the DRAM 14. Accordingly, the ban of operating the function concerned is implemented. Further, at the next activating time, by confirming the upper limit value, and then, controlling the apparatus not to download the control program for which the counted value of the corresponding one of download counters 61 has reached up to the upper limit value, it becomes possible to reduce the burden for the downloading operation.

Further, at every time when the processing of the job, which employs the specific extended function with respect to the control program downloaded, is completed, one of the operation counters 62, corresponding to the specific extended function, is counted up. Basically, the corresponding one of the operation counters 62 is counted up by “1” for every one implementation of the job. It is also applicable, however, that the image processing apparatus 10 is also provided with such a function that the corresponding one of the operation counters 62 is automatically counted up at every time just after the processing time has exceeded a predetermined time period. The condition for counting up operation can be changed by the serviceperson, etc.

The arithmetic calculation of the account fee for each function is conducted on the basis of each of the counted values of the download counters 61 and the operation counters 62. With respect to the accounting method, the following methods can be considered.

### 1) Accounting Method for the Downloading Operation

1-1) A unit fee for one downloading operation is established, so that the download counters 61 counts a number of downloading times so as to charge the account fee for every predetermined time period. In this case, it is applicable that, when the number of downloading times has exceeded an upper limit number established in advance, the account fee for the downloading operation after that is set at free.

1-2) A number of downloading times allowed for a predetermined time period is limited, and a predetermined fee is charged in advance. When the number of downloading times has exceeded an allowable number established in advance, the implementation of the corresponding function is banned until the predetermined time period has elapsed, or a fee for one downloading operation, separately established, is charged in addition to the predetermined fee. The above setting can be changed by the serviceperson, etc.

### 2) Accounting Method for Use of the Function Provided by the Control Program Downloaded

2-1) A unit fee for one use of the function (until the job is completed) is established, so that the operation counters 62 counts a number of using times so as to charge the account fee for every predetermined time period. It is applicable that the unit fee is established in such a manner that the more the number of using times increases, the lower the unit fee decreases.

2-2) A number of downloading times allowed for a predetermined time period is limited, and a predetermined fee is charged in advance. When the number of using times has exceeded an allowable number established in advance, the use of the corresponding function is banned until the predetermined time period has elapsed, or a fee for one using operation, separately established, is charged in addition to the predetermined fee. The above setting can be changed by the serviceperson, etc.

### 3) Accounting Method Employing Both the Number of the Downloading Times and the Number of Using Times

3-1) A unit fee for every downloading operation is established so that the download counters 61 counts a number of downloading times, and at the same time, a unit fee for one use of the function (until the job is completed) is also established so that the operation counters 62 counts a number of using times. The total fee of the account fee based on the number of downloading times and the account fee based on the number of using times is charged for every predetermined time period. In this case, it is applicable that the account fee for the number of using times until the predetermined number is included in the unit fee of the downloading operation, and only for the use exceeding the predetermined number after downloading, the unit charge for every using is added to the fee.

3-2) A number of downloading times allowed for a predetermined time period is limited, and-a predetermined fee is charged in advance. When the number of downloading times has exceeded an allowable number established in advance, the implementation of the corresponding function is banned until the predetermined time period has elapsed, or a unit fee, separately established, is charged for every downloading operation or for every function use in addition to the predetermined fee. Incidentally, each of the unit fee for every downloading operation and the unit fee for every function use is independently established for every function.

As mentioned in the foregoing, since the user can select the extended function to be acquired by downloading the control program from the downloading servers 5, and the account fee is calculated corresponding to the number of downloading times, the operating time (a holding period) after downloading, the number of function uses, etc., it becomes possible for the user to instantaneously use the desired extended function by turning either ON or OFF the downloading operation and reactivating the apparatus, without purchasing the desired extended function, having a little using frequency for the user, as an initial investment.

For instance, assuming that an optional function costing 50 thousands yen would be operated for five years after purchasing the apparatus, and the user would download the control program of the concerned optional function about twenty times a year (equivalent to about 1/10 of the working days a year), the total number of downloading operations within a range of five years becomes 100 times. Accordingly, when the account fee is calculated by employing the download counters 61, a unit cost per one downloading operation can be set at 500 yen (namely, (50 thousands yen)/(100 times)).

Further, when the account fee is calculated by employing the operation counters 62, assuming that a number of operating times per one year would be 100 times, the total number of operating times within a range of five years becomes 500 times. Accordingly, a unit cost per one operating time can be set at 100 yen (namely, (50 thousands yen)/(500 times)).

In normal cases, each fee for most of the operational functions is set at a price in a range of several ten thousands yen-100 and several ten thousands yen. However, if the account fee is calculated corresponding to the number of downloading times and/or the number of operating times, it becomes possible to suppress the unit cost per one time at a low level as aforementioned. As a result, the user can easily use various kinds of operational functions or introduce them as trial without increasing economical burdens for the user. Specifically, by setting the account fee for the operation for further downloading the control program with respect to the function for which the counted value of the download counters 61 has already reached to the upper limit number, or the account fee for the use of the function for which the counted value of the operation counters 62 has already reached to the upper limit number, at free (or zero), it becomes possible to prevent the account fee form being further charged onto the user while exceeding the price when totally purchasing them at once, resulting in a realization of the reasonable sales system without generating loss of the user.

Next, operation flows with respect to the account fees in various kinds of cases will be detailed in the following.

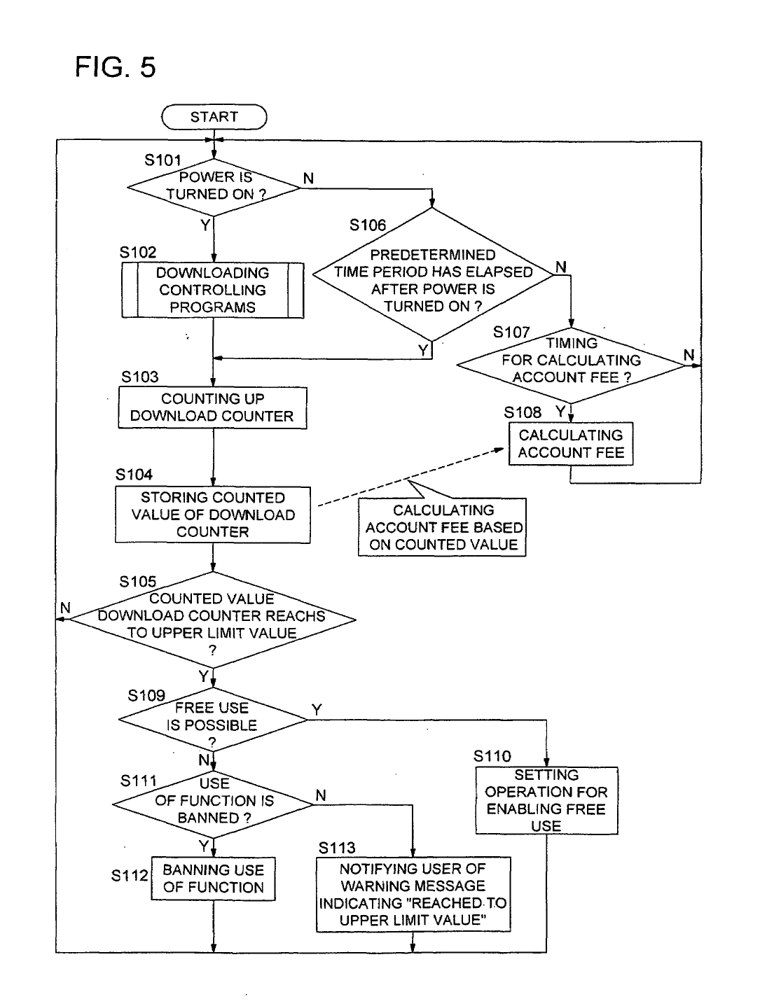

FIG. 5 shows a flowchart of operations for accumulating the downloading times in order to charge the account fee for every predetermined time period. When the power source is turned ON from OFF (Step S101; Y), referring to the selection information 63 stored in the nonvolatile storage 13 in the initial processing at the time when the power source turns ON, the image processing apparatus 10 downloads the control programs corresponding to the functions concerned from the downloading servers 5 (Step S102). Then, each of the download counters 61 corresponding to each of the functions downloaded is counted up (Step S103) and stores the counted value (Step S104).

When the power source is not turned ON just after OFF (Step S101; N), at every time when the predetermined time period has elapsed, each of the download counters 61 corresponding to each of the functions downloaded in the initial processing is counted up (Step S103) and stores the counted value (Step S104). When the counted value of each of the download counters 61 has not reached to the upper limit value established in advance (Step S105; N), the operation returns to Step S101 to continue the processing.

When timing for calculating the account fee arrives after the power source is turned ON (Step S107; Y), the account fee is calculated on the basis of the counted value of each of the download counters 61 (Step S108). The account fee calculated in the above is collected according to a predetermined collecting method. For instance, the account fee is automatically charged directly to the user's bank account or a debit note is issued to the user.

When the counted value of each of the download counters 61 has reached to the upper limit value (Step S105; Y), the image processing apparatus 10 investigates setting contents in regard to the use after the counted value has reached to the upper limit value. When the free use is set (Step S109; Y), a setting operation for enabling the free use is conducted (Step S110), and then, the process returns to Step S101 to continue the processing. For instance, a method for banning the count-up operation of the download counters 61 after that, a method for setting not to charge the account fee in the account fee calculation processing in Step S107, etc. are available for this purpose.

When setting contents in regard to the use after the counted value has reached to the upper limit value is not set at the free use (Step S109; N), the image processing apparatus 10 investigates whether or not the setting contents is set at a stoppage of using the function concerned (Step S111). When the stoppage of using the function concerned is set (Step S111; Y), the use of the function concerned after that time is banned (Step S112), and then, the process returns to Step S101 to continue the processing. For instance, the use of the function concerned after that is banned by disabling the selecting operation of the function concerned from the operational panel section 15.

When the stoppage of using the function concerned is not set (Step S111; N), a warning message, indicating “reached to the upper limit value” is displayed (Step S113), and then, the process returns to Step S101 to continue the processing. For instance, when the operation for implementing the job in regard to the function concerned is conducted after the counted value has reached to the upper limit value, the message for notifying the user of the current status, such as “the use of the function concerned is currently banned”, etc., is displayed on the apparatus.

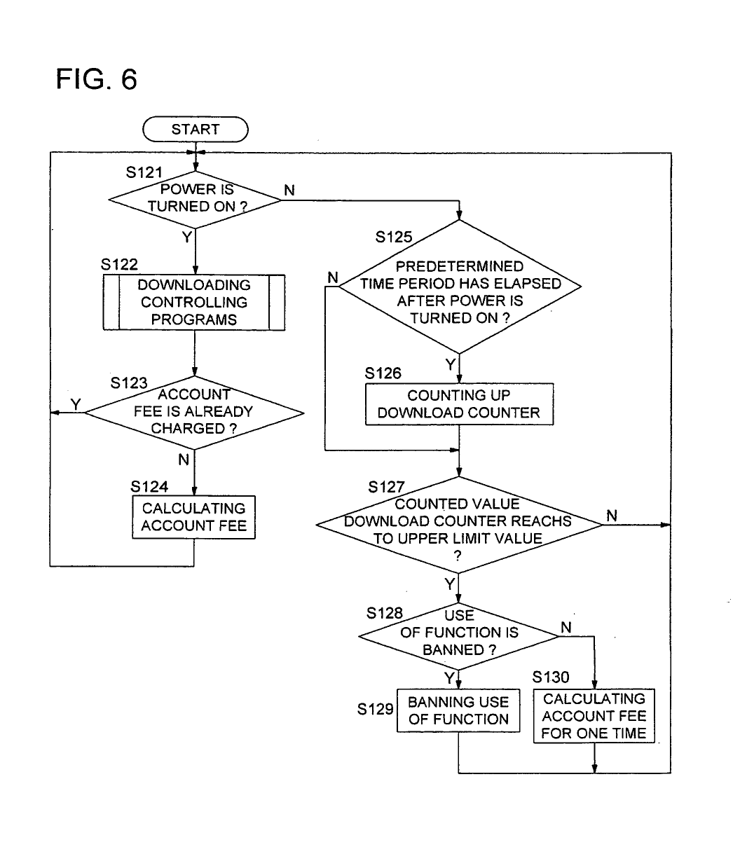

FIG. 6 shows a flowchart of operations for limiting the number of downloading times within the predetermined time period to charge the account fee established in advance. When the power source is turned ON from OFF (Step S121; Y), the image processing apparatus 10 downloads the control programs from the downloading servers 5 (Step S122). Then, the image processing apparatus 10 investigates whether or not the account fee is already charged (Step S123). When the account fee is not charged (Step S1; N), the arithmetic calculation of the account fee is conducted (Step S124). The account fee calculated in the above is collected according to the predetermined method.

When the power source is not turned ON just after OFF (Step S121; N), at every time when the predetermined time period has elapsed (Step S125; Y), each of the download counters 61 corresponding to each of the functions downloaded in the initial processing is counted up and stores the counted value (Step S126). When the counted value of each of the download counters 61 has not reached to the upper limit value established in advance (Step S127; N), the operation returns to Step S121 to continue the processing.

When the counted value of each of the download counters 61 has reached to the upper limit value (Step S127; Y), the image processing apparatus 10 investigates whether or not the setting contents in regard to the use after the counted value has reached to the upper limit value is set at a stoppage of using the function concerned (Step S128). When the stoppage of using the function concerned is set (Step S128; Y), the use of the function concerned after that time is banned (Step S129), and then, the process returns to Step S121 to continue the processing.

When the stoppage of using the function concerned is not set (Step S128; N), the calculation of the account fee for one time is conducted (Step S130), and then, the process returns to Step S121 to continue the processing. The collecting activity of the account fees would be conducted integrally at a predetermined date, etc.

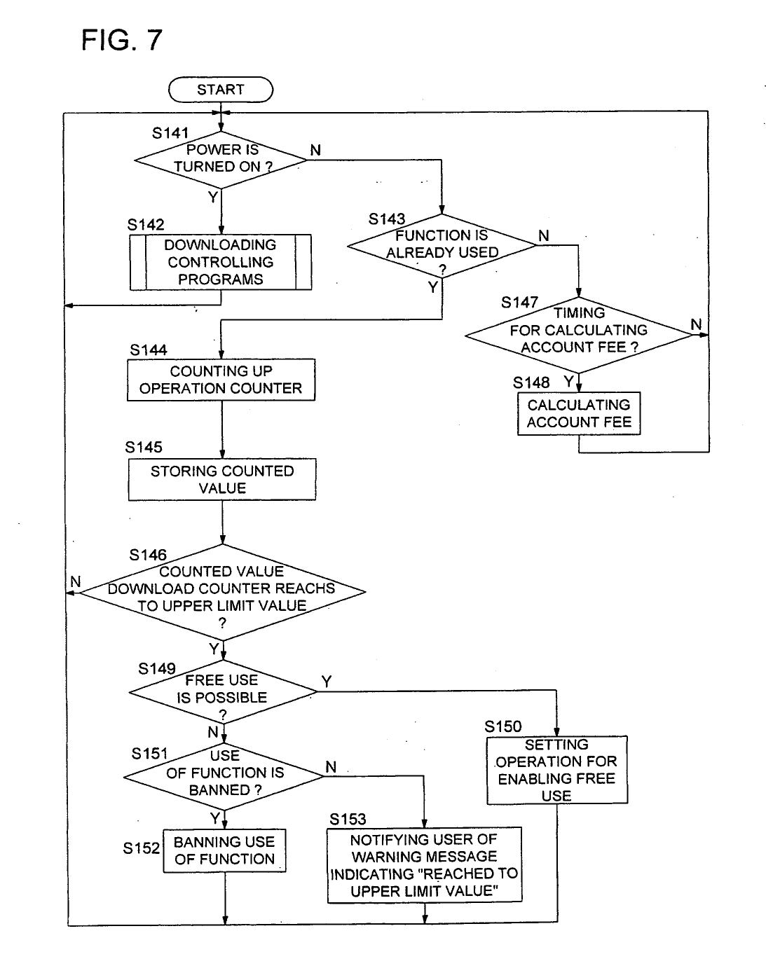

FIG. 7 shows a flowchart of operations for charging the account fee corresponding to the number of function uses. When the power source is turned ON from OFF (Step S141; Y), the image processing apparatus 10 downloads the control programs from the downloading servers 5 (Step S142). When the power source is not turned ON just after OFF (Step S141; N), the image processing apparatus 10 investigates whether or not the function in regard to the control program downloaded in the initial processing is already used (Step S143). When the function concerned is already used (Step S143; Y), one of the operation counters 62 corresponding to the function concerned is counted up (Step S144) and stores the counted value (Step S145). When the counted value of the corresponding one of the operation counters 62 has not reached to the upper limit value established in advance (Step S146; N), the operation returns to Step S141 to continue the processing.

When timing for calculating the account fee arrives after the power source is turned ON (Step S147; Y), the account fee is calculated on the basis of the counted value of the corresponding one of the operation counters 62 (Step S148). The account fee calculated in the above is collected according to a predetermined collecting method.

When the counted value of the corresponding one of the operation counters 62 has reached to the upper limit value (Step S146; Y), the image processing apparatus 10 investigates setting contents in regard to the use after the counted value has reached to the upper limit value. When the free use is set (Step S149; Y), a setting operation for enabling the free use is conducted (Step S150), and then, the process returns to Step S141 to continue the processing.

When setting contents in regard to the use after the counted value has reached to the upper limit value is not set at the free use (Step S149; N), the image processing apparatus 10 investigates whether or not the setting contents is set at a stoppage of using the function concerned (Step S151). When the stoppage of using the function concerned is set (Step S151; Y), the use of the function concerned after that time is banned (Step S152), and then, the process returns to Step S141 to continue the processing.

When the stoppage of using the function concerned is not set (Step S151; N), a warning message, indicating “reached to the upper limit value”, is displayed (Step S153), and then, the process returns to Step S141 to continue the processing.

Incidentally, in this embodiment, it is applicable that the number of using times of the function provided by the control program can be grasped by detecting a number of activating times or operating time of the control program in regard to the function concerned, or a number of implementing times of the job implemented by using the function concerned.

In the foregoing, referring to the drawings, the embodiments of the present invention have been described. The scope of the present invention is not limited to the embodiments described in the foregoing. Disclosed embodiments can be varied by a skilled person without departing from the spirit and scope of the present invention.

For instance, the arithmetic calculating method employing the download counters 61 and the operation counters 62 is not limited to those indicated in the embodiments. Any other arithmetic calculating method that calculates the account fee on the basis of the using status of the control program downloaded, such as a number of downloading times, a holding time in the DRAM 14 after downloading, a number of using times after downloading, etc., can be employed.

Further, although the user selects the desired function in the embodiment described in the foregoing, it is applicable that the accounting method of the present invention can be applied to such an apparatus that is used by downloading the control programs established in advance. Still further, it is also applicable that the control programs with respect to the fundamental functions, etc. are stored in the nonvolatile storage 13 or the HDD 12 of the image processing apparatus 10 in advance, without downloading from the downloading servers 5.

It is preferable that the control programs stored in the downloading servers 5 are divided into functional units being selectable by the image processing apparatus 10 when downloading them, or are divided into modules being finer than the functional units.

Further, the timing for downloading the control programs is not limited to the time when the power source is turned ON. It is applicable that user can designate an arbitral timing.

Still further, although the image processing apparatus detects the using status of the control programs downloaded, so as to charge the account fee based on the detected result in the embodiment described in the foregoing, it is also applicable that various kinds of control programs are installed in the image processing apparatus in advance, and the using status of the control programs installed in advance is detected, in order to charge the account fee based on this detected result.

Although the multi-function apparatus is cited as an embodiment to describe the present invention in the foregoing, it is needless to say that another kind of image processing apparatus, such as a copier, a printer, a facsimile apparatus, etc., is also applicable for the present invention.

According to the present invention, the following effects can be attained.
(1) It becomes possible to calculate the account fee corresponding to the using status of the control program downloaded from an external terminal device to temporarily store and use it, or corresponding to the using status of the control programs installed in the image processing apparatus in advance.
(2) By downloading the control program with respect to the function selected, it becomes possible not only to instantaneously provide the function desired by the user, but also to flexibly cope with changes and/or modifications of the function to be used.
(3) Since the account fee is calculated corresponding to the using the status of the control programs downloaded, it becomes possible for the user control program with respect to the desired function without purchasing it as the initial investment. As a result, it becomes possible for the user to use various kinds of functions with a little economical burden.

While the preferred embodiments of the present invention have been described using specific term, such description is for illustrative purpose only, and it is to be understood that changes and variations may be made without departing from the spirit and scope of the appended claims.

What is claimed is:

1. An image processing apparatus, which downloads control program from an external device and uses it, comprising:
an obtaining section to obtain the control program from the external device;
a storage section to temporarily store the control program;
a detection section to detect status of use of the control program; and
a calculation section to calculate fee for the control program based on the status of use of the control program.

2. The image processing apparatus of claim 1, further comprising:
a selection section to accept selection for a desired function, which becomes available at the image processing apparatus by obtaining the control program, wherein the obtaining section downloads and obtains control program corresponding to the selected function from the external device.

3. The image processing apparatus of claim 2,
wherein selectable function at the selection section by a user is extended capability.

4. The image processing apparatus of claim 1,
wherein the detection section detects the status of use of the control program in each function.

5. The image processing apparatus of claim 1,
wherein control program corresponding to basic function is excluded, when the calculation section calculates the fee.

6. The image processing apparatus of claim 1,
wherein the obtaining section downloads the control program from the external device, when the image processing apparatus turns on.

7. The image processing apparatus of claim 1,
wherein the storage section is a volatile memory.

8. The image processing apparatus of claim 1,
wherein the detection section detects the number of download of the control program.

9. The image processing apparatus of claim 1,
wherein the detection section detects time period of a retention for the control program.

10. The image processing apparatus of claim 1,
wherein the detection section detects the number of use of the control program.

11. The image processing apparatus of claim 1,
wherein control program, the status of use of which reaching a first value, is excluded, when the calculation section calculates the fee.

12. The image processing apparatus of claim 1,
wherein a criteria of control program, the status of use of which reaching a second value, is changed, when the calculation section calculates the fee.

13. An image processing apparatus, which provides a function by using a control program, comprising:
a storage section to store the control program;
a detection section to detect status of use of the control program; and
a calculation section to calculate fee for the control program based on the status of use of the control program.

14. The image processing apparatus of claim 13, further comprising:
a selection section to accept selection for a desired function available at the image processing apparatus,
wherein selected function is provided by using control program corresponding to the selected function.

15. The image processing apparatus of claim 14,
wherein selectable function at the selection section by a user is extended capability.

16. The image processing apparatus of claim 13, wherein the detection section detects the status of use of the control program in each function.

17. The image processing apparatus of claim 13,
wherein control program corresponding to basic function is excluded, when the calculation section calculates the fee.

18. The image processing apparatus of claim 13,
wherein the storage section is a nonvolatile memory.

19. The image processing apparatus of claim 13,
wherein the detection section detects time period of a retention for the control program.

20. The image processing apparatus of claim 13,
wherein the detection section detects the number of use of the control program.

21. The image processing apparatus of claim 13,
wherein control program, the status of use of which reaching a first value, is excluded, when the calculation section calculates the fee.

22. The image processing apparatus of claim 13,
wherein a criteria of control program, the status of use of which reaching a second value, is changed, when the calculation section calculates the fee.
